(19) United States
(12) Patent Application Publication
(10) Pub. No.: US 2002/0178312 A1
(43) Pub. Date: Nov. 28, 2002

(54) Calculator capable of displaying processing status and stopping processing and method of the same

(76) Inventors: Frank Chen, Taipei Hsien (TW); Gaai Ting Chong, Taipei Hsien (TW)

Correspondence Address: BACON & THOMAS, PLLC, 625 SLATERS LANE, FOURTH FLOOR, ALEXANDRIA, VA, 22314

(21) Appl. No.: 09/863,326

(22) Filed: May 24, 2001

(51) Int. Cl. G06F 13/24

(52) U.S. Cl. 710/260

(57) ABSTRACT

The present invention relates a calculator capable of displaying processing status and stopping processing and method of the same. In the present invention, an output unit displays a message representing that the expression is in processing and a counter begins to count after inputting an expression into the calculator. When the counter reaches a first predefined value and the calculation is not finished, a terminating message is shown to inquire the user to choose whether to continue or stop the processing.

### BACKGROUND OF THE INVENTION

1. Field of the Invention

The present invention relates to a calculator and, more particularly, to a calculator that can display processing status and stop processing, and method of the same.

2. Description of the Related Art

Currently, a calculator is in widely spread use to conveniently perform mathematical operations because of its fast and precise calculation capability. However, for a scientific calculator, it may take quite a long time to processing a complex mathematical expression, such as an integral expression. When such an expression is entered into a calculator to perform an operation, the user usually has to wait for a long time until the output is displayed. However, because there is no information about the processing status displayed when the expression is executing, it's hard for the user to determine whether to continue or stop the processing. If the waiting time is too long, the user may think that the calculator is crashed due to inputting an illegal expression, and thus turn off the calculator, which results in wasting time and low efficiency. Accordingly, there is a need for the above conventional calculator to be improved.

### SUMMARY OF THE INVENTION

The object of the present invention is to provide a calculator capable of displaying processing status and stopping processing and method of the same, by which the calculator can keep on processing during displaying an inquiry message, so that the problems of prior technologies can be improved and the hardware resource of the calculator can be efficiently utilized.

To attain the above object, the calculator in accordance with the present invention includes: an input unit adapted for being operated by a user to input an expression into the calculator; an algebraic logic processor for controlling and processing the input expression; an interrupt detector for detecting a request to stop processing when the expression is processed by the algebraic logic processing unit; a counter for counting based on a predefined value when the expression is processed by the algebraic logic processing unit; and an output unit for displaying processing status of the calculator and calculating results, and displaying a message representing that the expression is processing when the expression is processed by the algebraic logic processing unit; wherein, when the counter counts to a first predefined value before the algebraic logic processing unit finishes processing, the output unit displays a terminating message adapted to inquire the user whether to stop the processing or continue the processing, while the algebraic logic processor keeps processing the input expression.

Correspondingly, the method of the present invention includes steps of: (A) displaying a message indicating that the expression is processing and begins to count when an expression is input into the calculator for being processed; (B) displaying a terminating message adapted for inquiring a user whether to stop processing when counting to a first predefined value and the processing being not completed, while the expression is kept in processing; and (C) stopping or continuing processing based on a request from the user.

Further benefits and advantages of the present invention will become apparent after a careful reading of the detailed description with appropriate reference to the accompanying drawings.

### BRIEF DESCRIPTION OF THE DRAWINGS

FIG. 1 is a block view of a calculator in accordance with the present invention;

FIGS. 2A and 2B show the operating flowchart of the calculator in accordance with the present invention; and

FIGS. 3A-3E show an operation example of the calculator in accordance with the present invention.

### DETAILED DESCRIPTION OF THE INVENTION

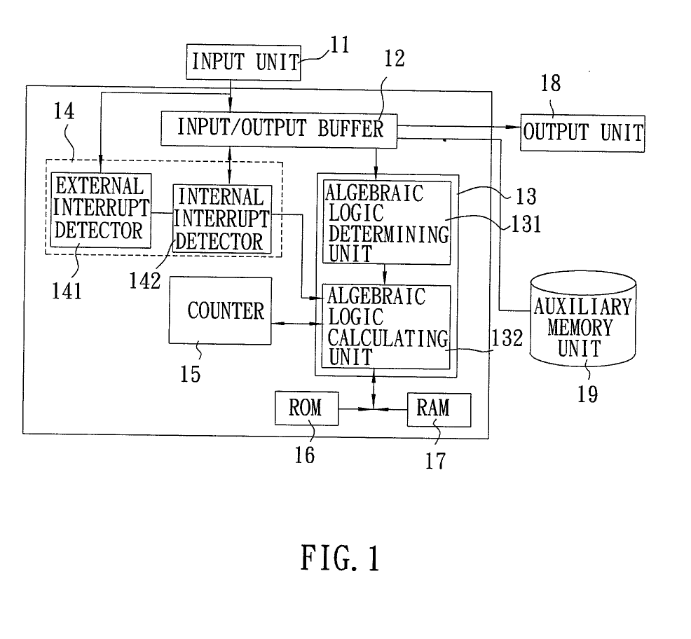

Referring to FIG. 1, a block view of a calculator capable of displaying processing status and stopping processing in accordance with the present invention is shown, which includes an input unit 11, an input/output buffer 12, an algebraic logic processor 13, an interrupt detector 14, a counter 15, a read-only memory (ROM) 16, a random accessing memory (RAM) 17, an output unit 18, and an auxiliary memory unit 19. The components 12-17 can be integrated in a processor on the calculator so as to provide the functions of logic operation and control.

The input unit 11 aforementioned can be, for example, a keypad for being operated by a user. The output unit 18 can be a LCD device for displaying the processing status and processing results of the calculator. The auxiliary memory unit 19 can be a flash memory device, which is used together with the ROM 16 and RAM 17 to provide the programming codes and memory spaces required for operating the calculator.

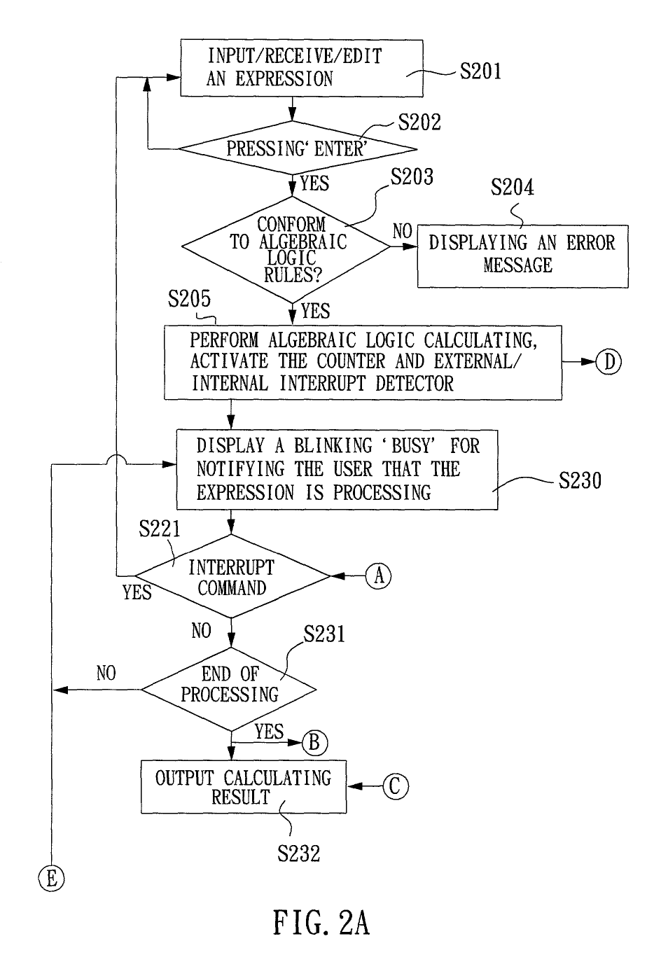

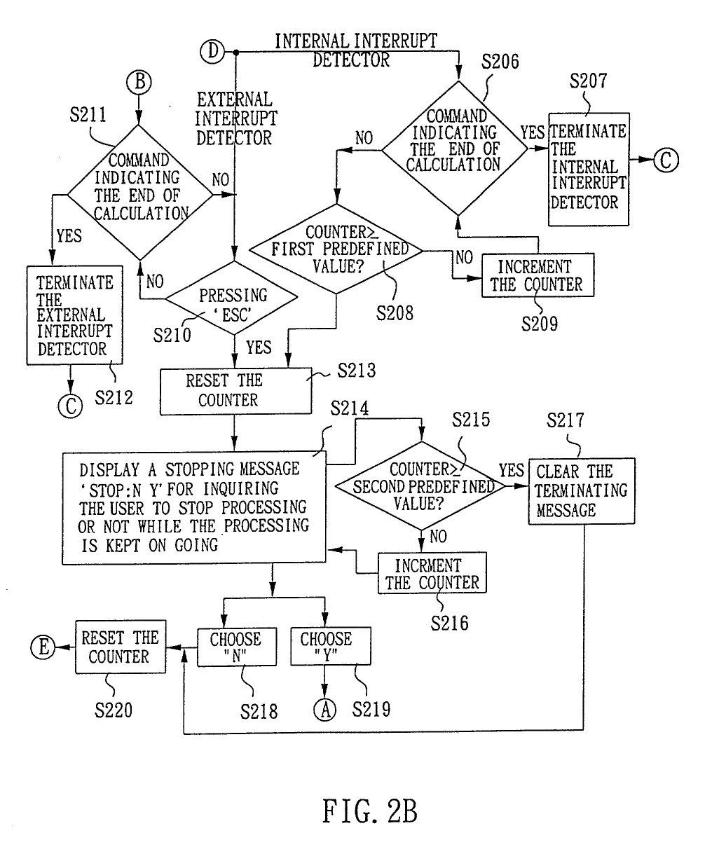

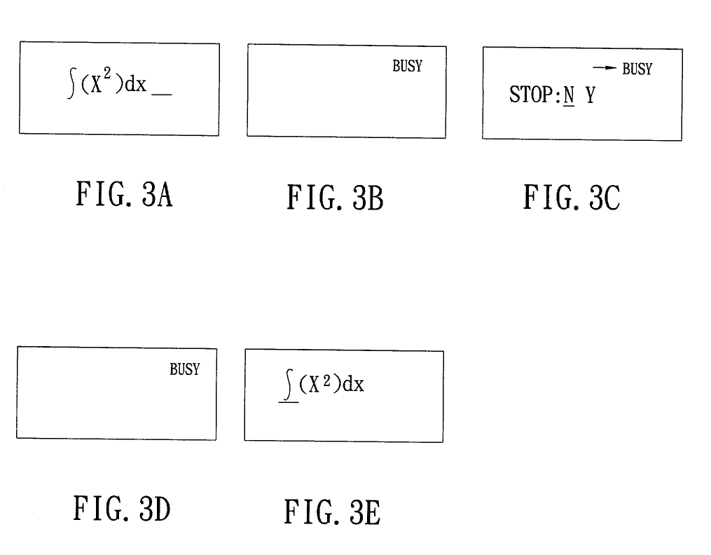

FIGS. 2A and 2B show the flowchart of the calculator in executing an expression. First, a user operates the input unit 11 to key in an expression into the input/output buffer 12, as shown as FIG. 3A, and then edits the expression (Step S201). After completing the input of the expression, the user presses a button ‘ENTER’ of the input unit 11 to input the expression (Step S202). Then, an algebraic logic determining unit 131 of the algebraic logic processor 13 determines whether the expression conforms to the algebraic logic rules (Step S203). If no, the output unit 18 displays an error message to notify the user of such (Step S204). If yes, an algebraic logic calculating unit 132 of the algebraic logic processor 13 starts to calculate the expression, and activates the counter 15, and an external interrupt detector 141 and an internal interrupt detector 142 of the interrupt detector 14, so as to begin to count and detect whether there is a request to stop the processing (Step S205).

When the calculator begins to execute the input expression, the output unit 18 displays a blinking message ‘busy’ (or other similar words), as shown in FIG. 3B, for notifying the user that the calculation is ongoing (Step S230). If no request for stopping the processing is received from the user and the calculation is finished (Step S231), a command indicating the end of calculation is sent out and the calculating result is output (Step S232).

The internal interrupt detector 142 is used together with the counter 15 for providing an inquiring function during processing a calculation with a long calculation time. In Step S206 of FIG. 2B, the calculator determines whether there is a command indicating the end of calculation. If yes, the internal interrupt detector 142 is terminated (Step S207) and the calculating result is output (Step S232). If no, it is checked whether the value of the counter 15 is lager than a first predefined value (Step S208). If no, the counter 15 is incremented (Step S209) and the calculator continues to determine whether there is a command indicating the end of calculation. (Step S206). The above first predefined value can be default in the system or determined by the user. In addition, the external interrupt detector 141 is used to detect whether a button ‘ESC’ is pressed by the user to stop the calculation (Step S210). If no, it is further determined whether there is a command indicating the end of calculation (Step S211). If yes, it indicates that the calculation is completed, and thus the external interrupt detector 141 can be terminated (Step S212) and the result is output (Step S232). If there is no command indicating the end of calculation in Step S211, it is then detected whether the key ‘ESC’ is pressed by the user (Step S210).

In case that the key ‘ESC’ is pressed by the user to stop the calculation in Step S210, or the time for calculating is over than a predefined period so that the value of the counter 15 is lager than the first predefined value in Step S208, the counter 15 will be reset (Step S213), and the output unit 18 will display a terminating message, such as ‘STOP : N Y’, as shown in FIG. 3C, for inquiring the user whether to stop the calculation or not. Meanwhile, the algebraic logic calculating unit 132 still keeps on processing the expression (Step S214). Additionally, after the terminating message is displayed, the calculator begins to determine whether the value of the counter 15 is larger than a second predefined value, wherein the second predefined value is the time period for displaying the terminating message (Step S215). If no, the counter 15 is incremented and the terminating message is still in display. If yes, it indicated that the user does not respond to whether to stop the calculation or not in a predefined time period, and therefore the terminating message is cleared (Step S217) and the counter 15 is reset (Step S220). Then, the Step S230 is performed again to display a blinking message ‘busy’ in the output unit 18 for notifying the user that the calculation is in processing.

If the user dose not want to stop calculation and chooses ‘N’ in the time period for displaying the terminating message (Step S218), the counter 15 is reset (Step S220) and the Step S230 is performed again to display a blinking message ‘busy’ in the output unit 18, as shown in FIG. 3D, for notifying the user that the calculation is in processing. On the contrary, if the user wants to stop calculation and chooses ‘Y’ in the time period for displaying the terminating message (Step S219), the calculator determines that there is an interrupt command (Step S221), and thus terminates the algebraic logic calculating unit 132. Then, the Step S201 is executed for receiving an expression, as shown in FIG. 3E.

In view of the foregoing, it is appreciated that the calculator and method of the present invention can display the processing status to avoid that the user erroneously determines the calculator being in crash. Furthermore, due to the inquiring function of the present invention, the calculator and method can provide alternatives for the user to determine whether to continue or stop processing by operating the input unit without influencing the processing status of the calculator. If there is no response to the inquiry in a certain period of time, the message is cleared and will appear again after a certain period of time until a stopping request is received or the calculation is finished. Even though the user presses the key ‘ESC’ by mistake, it is still possible to continue processing. Therefore, the present invention is capable of providing the user to conveniently operate the calculator for processing complicated calculations. Additionally, when the inquiry message is displayed on the screen, the calculator still continues calculating, so that the hardware resource of the calculator can be efficiently utilized.

Although the present invention has been explained in relation to its preferred embodiment, it is to be understood that many other possible modifications and variations can be made without departing from the spirit and scope of the invention as hereinafter claimed.

What is claimed is:

1. A calculator capable of displaying processing status and stopping processing, comprising:
an input unit adapted for being operated by a user to input an expression into the calculator;
an algebraic logic processor for controlling and processing the input expression;
an interrupt detector for detecting a request to stop processing when the expression is processed by the algebraic logic processing unit;
a counter for counting based on a predefined value when the expression is processed by the algebraic logic processing unit; and
an output unit for displaying processing status of the calculator and calculating results, and displaying a message representing that the expression is processing when the expression is processed by the algebraic logic processing unit;
wherein, when the counter counts to a first predefined value before the algebraic logic processing unit finishes processing, the output unit displays a terminating message adapted to inquire the user whether to stop the processing or continue the processing, while the algebraic logic processor keeps processing the input expression.

2. The calculator as claimed in claim 1, wherein the counter is reset to count based on a second predefined value and begins to count after the terminating message is displayed, and if no request from the user is detected after the counter counts to the second predefined value, the terminating message is cleared and the counter is reset to count based on the first predefined value.

3. The calculator as claimed in claim 2, wherein the output unit displays a message representing that the expression is processing after the stopping message is cleared.

4. The calculator as claimed in claim 2, wherein the interrupt detector has an internal interrupt detector for detecting a request to stop processing from a user.

5. The calculator as claimed in claim 4, wherein the interrupt detector has an external interrupt detector for detecting whether a specific key of the input unit is pressed by the user, and the output unit displays a terminating message for inquiring the user whether to stop processing when the expression is processed by the algebraic logic processing unit.

6. The calculator as claimed in claim 2, wherein the algebraic logic processor comprises:
an algebraic logic determining unit for determining whether the input expression confirms to algebraic logic rules; and
an algebraic logic calculating unit for calculating the expression which confirms to the algebraic logic rules.

7. A method capable of displaying processing status and stopping processing of a calculator when an expression is processing, comprising steps of:
(A) displaying a message indicating that the expression is processing and begins to count when an expression is input into the calculator for being processed;
(B) displaying a terminating message adapted for inquiring a user whether to stop processing when counting to a first predefined value and the processing being not completed, while the expression is kept in processing; and
(C) stopping or continuing processing based on a request from the user.

8. The method as claimed in claim 7, wherein, in step (B), when the terminating message is displayed, the calculator begins to count based on a second predefined value, and if there is no response from the user before counting to the second predefined value, the terminating message is cleared and the calculator begins to count based on the first predefined value again.

9. The method as claimed in claim 8, when the terminating message is cleared, a message representing that the expression is processing is displayed.

10. The method as claimed in claim 8, wherein, after an expression is inputted for being processed, a terminating message for inquiring a user whether to stop calculating is displayed by pressing a specific key of the calculator.

11. The method as claimed in claim 8, wherein, in step (A), it is determined whether the expression conforms to algebraic logic rules before calculating the expression.
